(19) United States
(12) Patent Application Publication
(10) Pub. No.: US 2025/0038361 A1
(43) Pub. Date: Jan. 30, 2025

(54) ELECTROCHEMICAL ENERGY STORAGE ELEMENT

(71) Applicant: VARTA Microbattery GmbH, Ellwangen Jagst (DE)

(72) Inventors: David Ensling, Ellwangen (DE); Rainer Hald, Ellwangen (DE); Alexander Hoefling, Ulm (DE); Raffael Ruess, Ellwangen (DE); Jonathan Schimmele, Jagstzell (DE)

(21) Appl. No.: 18/779,167

(22) Filed: Jul. 22, 2024

(30) Foreign Application Priority Data
Jul. 28, 2023 (EP) 23188393.5

(51) Int. Cl. H01M 50/46; H01M 4/04; H01M 4/66; H01M 4/75; H01M 10/04

(52) U.S. Cl. CPC H01M 50/46; H01M 4/0404; H01M 4/667; H01M 4/75; H01M 10/0431

(57) ABSTRACT

An electrochemical energy storage element includes an electrode-separator assembly that includes an anode, a cathode, and at least one separator or solid electrolyte. The anode and cathode each include an anode current collector in the form of an electrically conductive substrate having a top side, a bottom side, and an edge. The anode current collector and/or the cathode current collector includes a main region loaded on both sides with a layer of electrode material and an edge region not loaded with the electrode material that extends in a strip-shaped manner along the edge of the current collector. The electrode-separator assembly has a side from which a respective edge protrudes. A respective edge region extending along the respective edge is partially or completely coated with an electrically non-conductive layer of a support material.

### CROSS REFERENCE TO RELATED APPLICATIONS

This application claims benefit to European Patent Application No. EP 23188393.5, filed on Jul. 28, 2023, which is hereby incorporated by reference herein.

### FIELD

The present disclosure relates to an electrochemical energy storage element comprising an electrode-separator assembly.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, between which a separator is arranged. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current is made possible by an ion-conducting electrolyte.

If the discharge is reversible, i.e. if it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or strip-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example.

Furthermore, the electrodes can comprise an electrode binder (e.g. polyvinylidene fluoride (PVDF) or another polymer, such as carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells usually comprise solutions of lithium salts such as lithium hexafluorophosphate (LiPF₆) in organic solvents (e.g. ethers and esters of carbonic acid).

During the production of a lithium-ion cell, composite electrodes are usually combined with one or more separators to form an electrode-separator assembly.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in electric tools, lithium-ion cells with the highest possible energy density are required that are also capable of withstanding high currents during charging and discharging.

Cells for the applications mentioned are often designed as cylindrical round cells, for example with a form factor of 21×70 (diameter*height in mm). Cells of this type always comprise an assembly in the form of a winding. Modern lithium-ion cells of this form factor can achieve an energy density of up to 270 Wh/kg.

WO 2017/215900 A1 describes cylindrical round cells in which the electrode-separator assembly and its electrodes are ribbon-shaped and in the form of a winding. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact sheet metal member which sits on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

However, the problem with the cells described in WO 2017/215900 A1 is that it is difficult to weld the longitudinal edges and the contact sheet metal members together. In relation to the contact sheet metal members, the current collectors of the electrodes are extremely thin. The edge area of the current collectors is therefore mechanically sensitive and can be unintentionally deformed or melted down during the welding process. Furthermore, the separators of the electrode-separator assembly can melt when the contact sheet metal members are welded on. In extreme cases, this can result in short circuits.

It is known from WO 2020/239512 A1 to coat the surfaces of current collectors at the edges with a support material that is thermally more stable than the surface coated with it. Such a support material can stabilize the edge area of current collectors and insulates the current collectors in a particularly critical region.

It is also known from US 2020/0144676 A1 to coat the edge area of current collectors with a ceramic material.

### SUMMARY

In an embodiment, the present disclosure provides an electrochemical energy storage element. The electrochemical energy storage element includes an electrode-separator assembly. The electrode-separator assembly includes an anode, a cathode, and at least one separator or solid electrolyte with a sequence anode/separator or solid electrolyte/cathode. The anode includes an anode current collector in the form of an electrically conductive substrate having a top side, a bottom side, and an edge. The cathode includes a cathode current collector in the form of an electrically conductive substrate having a top side, a bottom side, and an edge. The anode current collector can include a main region loaded on both sides with a layer of negative electrode material and an edge region not loaded with the negative electrode material that extends in a strip-shaped manner along the edge of the anode current collector. The cathode current collector can include a main region loaded on both sides with a layer of positive electrode material, and an edge region not loaded with the positive electrode material that extends in a strip-shaped manner along the edge of the cathode current collector. The electrode-separator assembly has a side from which a respective edge protrudes. The respective edge is the edge of the anode current collector or the edge of the cathode current collector. A respective edge region extending along the respective edge is partially or completely coated with an electrically non-conductive layer of a support material. The respective edge region is the edge region of the anode current collector or the edge region of the cathode current collector. A respective current collector comprising the respective edge protruding from the side has a first mean thickness D1 in a main region thereof and a maximum thickness D2 in an edge region thereof. The respective current collector is the anode current collector or the cathode current collector, and wherein D2≥D1.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1A provides a cross-sectional view of the current collector of an anode of an electrode-separator assembly with a preferred embodiment of the coating with the support material (variant 1);

FIG. 1B provides a cross-sectional view of the current collector of an anode of an electrode-separator assembly with a preferred embodiment of the coating with the support material (variant 2);

FIG. 1C provides a cross-sectional view of the current collector of an anode of an electrode-separator assembly with a preferred embodiment of the coating with the support material (variant 3);

FIG. 1D provides a cross-sectional view of the current collector of an anode of the electrode-separator assembly with a preferred embodiment of the coating with the support material (variant 4);

FIG. 2 provides a detailed view of the edges of electrodes of an electrode-separator assembly in (cross-sectional view);

FIG. 3 illustrates a longitudinal section through an energy storage element with an electrode-separator assembly with contact sheet metal members; and

FIG. 4 illustrates an embodiment of an electrode-separator assembly and its components.

### DETAILED DESCRIPTION

The present disclosure provides energy storage elements characterized by a high energy density. In particular, the present disclosure provides for further improving the solutions described in WO 2020/239512 A1.

The present disclosure provides an electrochemical energy storage element characterized by an electrode-separator assembly in a housing. The assembly is characterized by the following features:
a. The assembly comprises as electrodes at least one anode and at least one cathode, as well as at least one separator or at least one solid electrolyte with the sequence anode/separator or solid electrolyte/cathode.
b. The anode comprises an anode current collector, which is preferably a thin, electrically conductive substrate having a top side, a bottom side and an edge.
c. The cathode comprises a cathode current collector, which is preferably a thin, electrically conductive substrate having a top side, a bottom side and an edge.
d. The anode current collector comprises a main region which is loaded on both sides with a layer of negative electrode material and an edge region which extends in a strip-shaped manner along the edge and which is not loaded with the negative electrode material,
and/or
the cathode current collector comprises a main region, which is loaded on both sides with a layer of positive electrode material, and an edge region, which extends along the edge in a strip-shaped manner and which is not loaded with the positive electrode material.
e. The assembly has one side from which the edge of the anode current collector or the edge of the cathode current collector protrudes from.
f. The edge area extending along the edge protruding from the side is partially or completely coated with an electrically non-conductive layer of a support material.
g. The electrode whose current collector comprises the edge protruding from the side has a first mean thickness D1 in the main area of its current collector and a maximum thickness D2 in the edge area coated with the layer of support material.
h. D2≤D1.

Feature h. in conjunction with feature g. ensures that there are no problems within the electrode-separator assembly in the region of the edge areas coated with the support material. If an electrode is thicker in the region of the edge area coated with the support material than in the main area loaded with the electrode material, this can cause mechanical stresses, as the elevated thicknesses can add up, for example in the case of spiral-wound electrodes.

The aforementioned mean thickness D1 can be determined by thickness measurements. For this purpose, thickness measurements are taken at several measuring points along a section perpendicular to the strip-shaped main region through the main region coated with the electrode material. The measurement results are added together and divided by the number of measurements to obtain D1. Preferably, at least six measurements are taken at six measuring points. It is further preferred that two terminal measuring points are each 2 mm away from the two ends of the cut and that the remaining measuring points divide the distance between the two terminal measuring points into equal distances.

The “section” is preferably not a mechanical cut. Rather, it is preferred to determine the mean thickness using sectional images that can be obtained by means of CT (computed tomography) analyses. This means that even electrodes that are part of an electrode-separator assembly located in a closed metal housing can be examined.

With regard to the coating with the support material, there are four preferred variants.

Variant 1 is characterized by at least one of the following features a. to c:
a. The edge area extending along the edge protruding from the side is partially coated with the layer of support material.
b. The edge region extending along the edge protruding from the side is subdivided into a first strip-shaped subregion which is free of the support material, a second strip-shaped subregion which is coated on both sides with the support material, and a third strip-shaped subregion which is also free of the support material.
c. The third strip-shaped subregion is a terminal strip-shaped subregion and the first strip-shaped subregion is immediately adjacent to the current collector main region and the second subregion separates the first strip-shaped subregion from the second strip-shaped subregion.

Preferably, the immediately preceding features a. to c. are realized in combination. Variant 2 is characterized by at least one of the following features a. to c:
a. The edge area extending along the edge protruding from the side is partially coated with the layer of support material.
b. The edge region extending along the edge protruding from the side is divided into a first strip-shaped subregion, which is coated on both sides with the support material, and a second strip-shaped subregion, which is free of the support material.
c. The second strip-shaped subregion is a terminal strip-shaped subregion and the first strip-shaped subregion is immediately adjacent to the main region of the current collector and separates the main region from the second strip-shaped subregion.

Preferably, the immediately preceding features a. to c. are realized in combination.

Variant 3 is characterized by at least one of the following features a. to c:
a. The edge area extending along the edge protruding from the side is completely coated with the layer of support material.
b. The edge area extending along the edge protruding from the side is coated on both sides with the layer of support material.

Preferably, the immediately preceding features a. and b. are realized in combination.

Variant 4 is characterized by at least one of the following features a. to d:
a. The edge area extending along the edge protruding from the side is partially coated with the layer of support material.
b. The edge region extending along the edge protruding from the side is divided into a first strip-shaped subregion, which is coated on both sides with the support material, and a second strip-shaped subregion, which is free of the support material.
c. The second strip-shaped subregion is a terminal strip-shaped subregion and the first strip-shaped subregion is immediately adjacent to the main region of the current collector and separates the main region from the second strip-shaped subregion.
d. The main area is partially or completely coated with the electrically non-conductive layer of support material.

Preferably, the immediately preceding features a. and b. are realized in combination.

The electrode-separator assembly may have a cylindrical or substantially cylindrical shape or a prismatic or substantially prismatic shape.

If it has a cylindrical or essentially cylindrical shape, it is preferably characterized by at least one of the features a. to g. immediately below:
a. The electrode-separator assembly has is a winding and comprises the anode and the cathode and the at least one separator or the at least one layer of the solid electrolyte, each in ribbon-shaped form and wound in a spiral.
b. The winding-shaped electrode-separator assembly has a first and a second end face and a winding shell between them.
c. The anode current collector is ribbon-shaped and comprises its main region and the edge region parallel to each other, whereby the main region is strip-shaped like the edge region.
d. The cathode current collector is ribbon-shaped and comprises its main region and the edge region parallel to each other, whereby the main region and the edge region are strip-shaped.
e. The edge of the anode current collector protrudes from one of the end faces, and the edge of the cathode current collector protrudes from the other end face.
f. A contact sheet metal member is fixed to the first and/or second end face.
g. The contact sheet metal member or the contact sheet metal members are welded to the edge or edges protruding from the respective end face.

Preferably, the immediately preceding features a. and e. are realized in combination. Preferably, the electrode-separator assembly is characterized by features a. to f. or features a. to g.

The side from which the edge of the anode current collector or the edge of the cathode current collector protrudes is therefore the first or the second end face if the electrode-separator assembly is cylindrical. The edge of the anode current collector according to feature e. immediately above is a longitudinal edge of the anode current collector. And the edge of the cathode current collector according to feature e. immediately above is a longitudinal edge of the cathode current collector.

In typical cases, the spirally wound electrode ribbons and the at least one separator ribbon preferably have the following dimensions:
A length in a range from 0.5 m to 25 m
A width in a range from 40 mm to 145 mm

To produce a wound electrode-separator assembly consisting of electrode ribbons and at least one ribbon-shaped separator, the ribbon-shaped electrodes and the at least one separator are generally fed to a winding device, where they are preferably wound in a spiral around a winding axis. Bonding of the electrodes and the separators or contacting at elevated temperatures is usually not necessary. In some embodiments, the electrodes and the at least one separator are wound onto a cylindrical or hollow-cylindrical winding core, which is seated on a winding mandrel and remains in the winding after winding.

The winding shell can be formed by a plastic film or an adhesive tape, for example. It is also possible for the winding shell to be formed by one or more separator windings.

If the electrode-separator assembly has an essentially prismatic shape, it is preferably characterized by at least one of the features a. to f. immediately below:
a. The electrode-separator assembly comprises a plurality of anodes and a plurality of cathodes in stacked form, adjacent electrodes of opposite polarity in the stack being separated by the at least one separator or the at least one layer of solid electrolyte.
b. The anode current collectors of the anodes each comprise the main region, which is loaded on both sides with a layer of the negative electrode material, and the edge region, which extends in strips along the edge and which is not loaded with the negative electrode material.
c. The cathode current collectors of the cathodes each comprise the main region, which is loaded on both sides with a layer of the positive electrode material, and the edge region, which extends in strips along the edge and which is not loaded with the positive electrode material.
d. The stack is prismatic and has a first side from which the edges of the anode current collectors protrude and a second side from which the edges of the cathode current collectors protrude.
e. A contact sheet metal member is fixed to the first and/or second side.
f. The contact sheet metal member or the metal contact sheet metal members are welded to the edges protruding from the respective side.

Preferably, the immediately preceding features a. and d. are realized in combination. Preferably, the electrode-separator assembly is characterized by features a. to e. or features a. to f.

In the essentially prismatic electrode-separator assembly, the current collector edges of the positive and negative electrodes can also protrude from more than one side of the electrode-separator assembly. For example, it may be provided that positive electrodes with a rectangular basic shape each have two strip-shaped edge regions not loaded with electrode material, which extend along one edge of the respective current collector and protrude from two adjacent sides of the electrode-separator assembly. In this case, the contact sheet metal member can, for example, be L-shaped and resting on both sides from which the respective edges protrude. Or two contact sheet metal members can be used.

In the case of the prismatic shape, the electrode-separator assembly preferably comprises a plurality of electrodes with a rectangular basic shape.

Furthermore, the electrode-separator assembly can also be formed as a flat coil with spirally wound ribbon-shaped electrodes and have an essentially prismatic shape.

The electrodes are preferably composite electrodes comprising electrochemically active components and electrochemically inactive components, the basic structure of which has already been explained in the introductory section.

The current collectors have the function of electrically contacting the electrochemically active components contained in the respective electrode material over as large an area as possible. Preferably, the current collectors consist of a metal or are at least metallized on the surface.

In the case of electrode materials for lithium-ion cells, suitable metals for the anode current collector include copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are particularly suitable as nickel alloys. Alloys of the type NiFe, NiCu, CuNi, NiCr and NiCrFe are particularly suitable as nickel alloys. Stainless steel can also be considered, for example type 1.4303 or 1.4404 or type SUS304.

In the case of lithium-ion cells, aluminum or other electrically conductive materials, including aluminum alloys, are particularly suitable as a metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a metal foil with a thickness in a range from 4 μm to 30 μm.

However, in addition to films, other substrates such as metallic or metallized nonwovens or open-pored metallic foams or expanded metals can also be used as current collectors, preferably also with a thickness in a range from 4 μm to 30 μm.

The separators are preferably formed from an electrically insulating plastic film. This preferably has pores so that it can be penetrated by the liquid electrolyte. The plastic film can consist of a polyolefin or a polyether ketone, for example. However, nonwovens and fabrics made of plastic materials or other electrically insulating fabrics can also be used as separators.

Separators with a thickness in a range from 5 to 50 μm are preferred.

The separators are preferably impregnated with a suitable electrolyte, as are the electrodes.

In the case of the prismatic electrode-separator assembly in particular, layers of the aforementioned solid electrolyte can also be used instead of separators. A solid electrolyte has an intrinsic ionic conductivity and does not need to be impregnated with a liquid electrolyte. The solid electrolyte can, for example, be a polymer solid electrolyte based on a polymer-conducting salt complex, which is present in a single phase without any liquid component. A polymer solid-state electrolyte can have polyacrylic acid (PAA), polyethylene glycol (PEG) or polymethyl methacrylate (PMMA) as the polymer matrix. Lithium conductive salts such as lithium bis-(trifluoromethane) sulfonylimide (LiTFSI), lithium hexafluorophosphate (LIPF₆) and lithium tetrafluoroborate (LIBF₄) can be present in these.

It is preferred that the sides of the electrode-separator assemblies, from which the edge or edges along which the strip-shaped edge region protrudes, are formed by the edges of the separators or solid electrolyte layers. For example, if a ribbon-shaped separator is arranged between oppositely polarized ribbon-shaped electrodes of a wound, cylindrically formed electrode-separator assembly, a longitudinal edge of this separator forms an end face of the cylindrically formed electrode-separator assembly. Generally, the distances between adjacent windings of the winding are very small. Ideally, the longitudinal edge spans a flat plane from which the longitudinal edge of one of the current collectors protrudes.

With regard to electrochemistry, the electrode-separator assembly is not limited to a specific cell type. In preferred embodiments, it comprises lithium ion-based electrodes. In alternative embodiments, it comprises electrodes based on sodium ion, potassium ion, calcium ion, magnesium ion or aluminum ion technology. Among these alternatives, electrodes with sodium-ion cell chemistry are preferred.

As is well known, cells with lithium-ion technology are based on the use of lithium, which can migrate back and forth between the electrodes of an energy storage element in the form of ions.

In principle, all materials that can absorb and release lithium ions can be used as electrochemically active components (active materials) for the electrodes of lithium-ion cells. For example, carbon-based particles such as graphitic carbon can be used for the negative electrode of the electrode-separator assembly. Suitable active materials for the positive electrode include lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

The active materials are generally the main component of the layer that is applied to the current collector. The current collector is an electrochemically inactive component of the energy storage element. Metallic foils are particularly suitable as current collectors. The current collector for the negative electrode (anode current collector) of a lithium-ion cell can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of said layer on the current collectors and often also ensures the adhesion of the layer to the current collectors. Common conductivity-enhancing additives are carbon black, fine graphite, carbon fibers, carbon nanotubes and metal powder.

Solutions of lithium salts such as lithium hexafluorophosphate (LiPF₆) in organic solvents (e.g. ethers and esters of carbonic acid) are particularly suitable as electrolytes for lithium-ion cells.

Cells with sodium-ion technology are known to be based on the use of sodium, which can migrate back and forth between the electrodes of an energy storage element in the form of ions.

For the electrodes of an electrode-separator assembly which is based on sodium-ion technology, the following materials, for example, can be used on the anode side:
Carbon, especially hard carbon (pure or with nitrogen and/or phosphorus doping) or soft carbon or graphene-based materials (e.g. with nitrogen doping); carbon nanotubes, graphite
Polyanions such as Na₂Ti₃O₇, Na₃Ti₂(PO₄)₃, TiP₂O₇, TiNb₂O₇, Na—Ti—(PO₄)₃, Na—V—(PO₄)₃
Transition metal oxides: V₂O₅, MnO₂, TiO₂, Nb₂O₅, Fe₂O₃, Na₂Ti₃O₇, NaCrTiO₄, Na₄TisO₁₂

On the cathode side, for example, the following materials can be considered:
Polyanions: NaFePO₄ (Triphylit-Typ), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, Na₄(CoMnNi)₃(PO₄)₂P₂O₇, NaCoPO₄, Na₂CoPO₄F
Silicates: Na₂MnSiO₄, Na₂FeSiO₄
Layered oxides: NaCoO₂, NaFeO₂, NaNiO₂, NaCO₂, NaVO₂, NaTIO₂, Na(FeCo)O₂, Na(NiFeCo)₃O₂, Na(NiFeMn)O₂, Na(NiFeCoMn)O₂, Na(NiMnCo)O₂

In addition, the electrodes of an electrode-separator assembly based on sodium ions preferably contain an electrode binder and/or a conductivity-improving and/or other additive.

In a sodium-ion energy storage cell, both the anode and the cathode current collector preferably consist of aluminum or an aluminum alloy.

Energy storage elements based on sodium-ion technology preferably have an electrolyte with at least one solvent and at least one conducting salt.

Organic carbonates, ethers, nitriles and mixtures thereof are particularly suitable as solvents.

Preferred conducting salts are NaPF₆, sodium difluoro (oxalato) borate (NaBOB), NaBF₄, sodium bis(fluorosulfonyl)imid (NaFSI), sodium 2 trifluoromethyl-4,5-dicyanoimidazole (NaTDI), sodium bis(trifluoromethansulfonyl)imide (NaTFSI), NaAsF₆, NaBF₄, NaClO₄, NaB(C₂O₄)₂, NaP(C₆H₄O₂)₃; NaCF₃SO₃, sodium triflate (NaTf) and Et₄NBF₄.

The contact sheet metal member of the electrode-separator assembly is preferably characterized by the following additional feature:
a. The contact sheet metal member has a preferably uniform thickness in a range from 50 μm to 600 μm, in particular in a range from 100 μm to 500 μm, preferably 200 μm or 300 μm.

A thickness of the contact sheet metal member of approx. 200 μm is particularly suitable for making contact with the anode or the negative electrodes and a thickness of the contact sheet metal member of approx. 300 μm is particularly suitable for making contact with the cathode or the positive electrodes.

In preferred embodiments the contact sheet metal member is characterized by the following additional feature:
a. The contact sheet metal member has at least one bead which is formed on one flat side of the contact sheet metal member as an elongate depression and on the opposite flat side as an elongate elevation, wherein the contact sheet metal member faces the electrode-separator assembly with the flat side which carries the elongate elevation.

Furthermore, in preferred embodiments, the electrode-separator assembly may be characterized by at least one of the following additional features:
a. The contact sheet metal member is welded to the electrode-separator assembly in the region of at least one bead.
b. The welds are linear.
c. The weld seams are formed by two or more parallel weld lines per bead.

Preferably, the aforementioned features a. and b. and, preferably, the aforementioned features a. to c., are realized in combination with one another.

By welding the contact sheet metal member in the region of the at least one bead to a current collector edge protruding from one side of the electrode-separator assembly or to several such edges, the stability of the weld and generally the welding contact with the electrodes can be further improved.

Preferably, the contact sheet metal member has two or three or more beads.

It may be provided that a central region of the contact sheet metal member has an aperture, for example in the form of a round hole. This aperture in the contact sheet metal member can be used when impregnating the electrode-separator assembly with an electrolyte liquid.

In some embodiments, it has proven advantageous to subject edges of current collectors protruding from one side of the electrode-separator assembly to a pretreatment before the contact sheet metal member is placed on top. In particular, at least one depression can be folded into the edge or edges, the position of which corresponds to the position of the at least one bead or the elongated elevation on the flat side of the contact sheet metal member facing the electrode-separator assembly.

The edge of the current collector or the edges of the current collectors can also be subjected to directional forming as part of pre-treatment, for example bending in a defined direction.

The contact sheet metal member can be electrically connected to the anode current collector or the cathode current collector of the electrode-separator assembly. As explained in WO 2017/215900 A1, the use of a contact sheet metal member has the advantage that the electrodes are in contact with the contact sheet metal member along their respective edges. This can generally reduce the internal resistance of the energy storage element, so that the occurrence of larger currents can be absorbed much better compared to classic energy storage elements.

A contact sheet metal member provided for electrical connection to an anode current collector of the electrode-separator assembly, in particular an electrode-separator assembly suitable for a lithium-ion cell, may be characterized by at least one of the following features:
a. The contact sheet metal member consists of nickel or copper or titanium or a nickel or copper or titanium alloy or stainless steel, for example of type 1.4303 or 1.4404 or of type SUS304, or of nickel-plated copper.
b. The contact sheet metal member and the anode current collector consist of the same material.

A contact sheet metal member, which is provided for electrical contacting with the cathode current collector of the electrode-separator assembly, in particular an electrode-separator assembly suitable for a lithium-ion cell, can preferably be characterized by at least one of the following features:
a. The contact sheet metal member consists of aluminum or an aluminum alloy.
b. The contact sheet metal member and the cathode current collector consist of the same material.

Suitable aluminum alloys for the contact sheet metal member include Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Furthermore, the contact sheet metal member may be characterized by at least one of the immediately following features a. to c:
a. The contact sheet metal member has two opposite flat sides and extends essentially in only one dimension.
b. The contact sheet metal member is a disk or a polygonal plate.
c. The contact sheet metal member is dimensioned such that it covers at least 40% of the side or end face of the electrode-separator assembly to which it is fixed, preferably at least 50%, preferably at least 60%, preferably at least 70%, preferably at least 80%.

Preferably, the immediately above-mentioned features a. and b. or a. and c. or b. and c. or, preferably, the immediately above-mentioned features a. to c. are realized in combination with one another.

Covering the side or end face of the electrode-separator assembly with the contact sheet metal member over as large an area as possible is advantageous for the thermal management of the electrode-separator assembly. The larger the cover, the easier it is to contact the longest possible sections of the respective electrodes. Heat generated in the electrode-separator assembly can thus be dissipated particularly well via the contact sheet metal member to a housing.

The support material of an electrode-separator assembly is preferably characterized by at least one of the features a. to c. immediately below:
a. The support material is a ceramic material.
b. The support material comprises ceramic particles and a binder.
c. The ceramic material or ceramic particles are boehmite (AlO(OH) or γ-AlOOH).

Preferred are ceramic materials with a melting point that is above the melting point of the respective material of the current collector supported by the ceramic material. Carbides, nitrides, oxides, silicides or mixtures and derivatives of these compounds are suitable, particularly in particle form. In preferred embodiments, the ceramic material is aluminum oxide (Al₂O₃), titanium oxide (TiO₂), titanium nitride (TiN), titanium aluminum nitride (TiAlN) or titanium carbonitride (TiCN).

As an alternative to the ceramic material, the support material can also be a glass-ceramic material or a glass. The term “glass-ceramic material” refers in particular to a material comprising crystalline particles embedded in an amorphous glass phase. The term “glass” basically means any inorganic glass that meets the thermal stability criteria defined above and is chemically stable with respect to any electrolyte that may be present.

The support material is preferably formed according to feature c. immediately above.

The binder according to the immediately preceding feature b. is preferably at least one binder from the group of the following compounds: Polytetrafluoroethylene (PTFE), polyvinylidene fluoride (PVDF), polyamide (PA), styrene-butadiene rubber (SBR), carboxymethyl cellulose (CMC), hydrogenated acrylonitrile butadiene rubber (HNBR), polyacrylic acid (PAA), polymethacrylate (PMA), polyacrylate (PA), polyvinyl acetate (PVA), polyacrylonitrile (PAN), polyethylene (PE), polyvinylpyrrolidone (PVP), polyvinylbutyral (PVB), polystyrene (PS), polyurethane (PU).

For example, fluorinated derivatives of the compounds mentioned are also suitable.

Energy storage elements are preferably characterized by the following features a. and b:
a. The energy storage element comprises an airtight and liquid-tight housing in which the electrode-separator assembly is arranged.
b. The electrode-separator assembly is electrically connected via the contact sheet metal member to a part of the housing or an electrical pole passing through the housing.

The housing in which the electrode-separator assembly is arranged is preferably an airtight and liquid-tight sealed housing.

The energy storage element can have a prismatic housing or a cylindrical housing. In the case of a prismatic housing, the electrode-separator assembly preferably has the described prismatic or essentially prismatic shape. In the case of a cylindrical housing, the electrode-separator assembly preferably has the described cylindrical or substantially cylindrical shape.

The housing is preferably formed from a cup-shaped metallic housing part and a lid part consisting at least partly of a metal. The cup-shaped housing part can be formed in a deep-drawing process, for example. However, it is also possible, for example, to produce it by welding a bottom into a tubular housing part. The two housing parts can be assembled together via a seal that has electrically insulating properties and electrically insulates the two housing parts from each other. It is also possible to join the two housing parts together by welding. In this case, a metallic pole insulated from the housing is generally led out through an aperture in the housing.

The electrical and thermal contact of the electrodes with the housing or at least one of the housing parts is made via the contact sheet metal member. The contact sheet metal member itself can, for example, be electrically connected to a housing part or the metal pole via a current conductor or by direct welding.

The housing parts can consist of aluminum, an aluminum alloy or a steel sheet, for example a nickel-plated steel sheet. Suitable aluminum alloys for the cup-shaped metallic housing part are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

The present disclosure further provides a method of manufacturing an electrochemical energy storage element with the described electrode-separator assembly. The method comprises the following method steps for manufacturing an electrode of the electrode-separator assembly:
a. Applying a layer of an electrode material in a main region of a current collector having a top side, a bottom side and an edge;
b. applying a layer of a support material in an edge region of the current collector which extends in a strip along the edge and which is not loaded with the electrode material, and
c. if necessary, calendering of the current collector coated with the layer of electrode material and the layer of support material,
wherein
d. the layer of electrode material and the layer of support material are selected and applied in such a way that the electrode produced has a first mean thickness D1 in the main area and a maximum thickness D2 in the edge area and D2≤D1.

The final thicknesses D1 and D2 and their ratio to each other are determined by the amount of support material and electrode material applied per unit area, as well as the compressibility of the layers during the optional step c., the calendaring. This is generally carried out using rollers that exert pressure on the layers and compress them. The optimum setting for these parameters can be easily determined in practice by means of experimental tests.

In this way, both anodes and cathodes can be produced and processed with separators in subsequent steps to form electrode-separator assemblies, as already explained above.

Preferably, the method is characterized by at least one of the features a. to g. immediately below:
a. A suspension comprising the support material in particulate form and a suspending agent is used to apply the layer of support material.
b. The suspending agent comprises at least one substance from the group consisting of water, N-methyl-pyrrolidone (NMP) and ethanol.
c. The suspension comprises a binder.
d. The suspension comprises the particulate support material with a d50 value in a range from 0.2 μm to 0.5 μm.
e. The suspension is free of particles with a particle size >2 μm.
f. The suspension comprises additives that influence its processing properties.
g. The suspension comprises the following components in the following proportions:

| | | |
|---|---|---|
| Suspension agent | 40-90% | by weight |
| Particulate support material | 10-60% | by weight |
| Binder | 1-20% | by weight |
| Additives | 0-5% | by weight |

The components in feature g. add up to a total of 100% by weight.

After the suspension has been applied to the current collector, the suspension agent contained in the suspension must be removed, for example with the help of heat and/or reduced pressure. This is generally followed by the aforementioned calendering process.

Further features and advantages are apparent from the following description of preferred examples in conjunction with the drawings. In this context, it should be noted that the features of the preferred embodiments shown in the examples are not necessarily linked to one another, but can also be realized independently of one another.

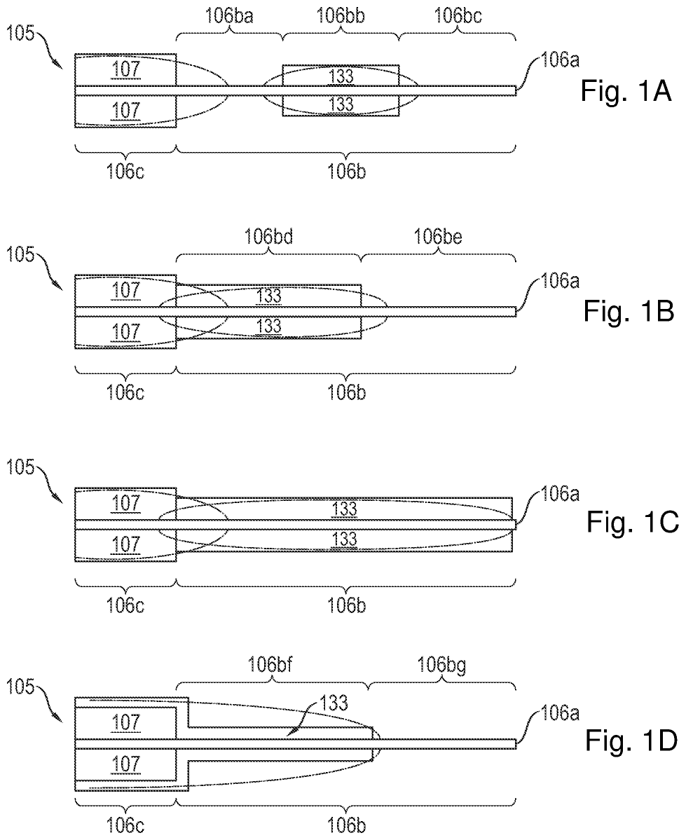

The current collector 106 of an anode 105 shown in FIG. 1A comprises an edge region 106b, which is coated on both sides with a layer of a support material 133, and a main region 106c, which is coated on both sides with a layer of an electrode material 107. The edge region 106b is subdivided into a first strip-shaped subregion 106ba, which is free of the support material 133, a second strip-shaped subregion 106bb, which is coated on both sides with the support material 133, and a third strip-shaped subregion 106bc, which is also free of the support material 133. The third strip-shaped subregion 106bc is a terminal strip-shaped subregion and the first strip-shaped subregion 106ba is directly adjacent to the strip-shaped main region 106c of the current collector and the second subregion 106bb separates the first strip-shaped subregion 106ba from the second strip-shaped subregion 106bb.

In practice, in many embodiments, the described main region 106c, the described edge region 106b and the described subregions 106ba, 106bb and 106bc are not as sharply delimited from one another as shown in the drawing. A possible course of the respective area boundaries is shown by dashed lines.

The current collector 106 of an anode 105 shown in FIG. 1B comprises an edge region 106b, which is coated on both sides with a layer of a support material 133, and a main region 106c, which is coated on both sides with a layer of an electrode material 107. The edge region 106b is coated with the layer of support material 133 only in some areas. It is subdivided into a first strip-shaped subregion 106bd, which is coated on both sides with the support material 133, and a second strip-shaped subregion 106be, which is free of the support material. The second strip-shaped subregion 106be is a terminal strip-shaped subregion and the first strip-shaped subregion 106bd is immediately adjacent to the main region 106c of the current collector and separates the main region 106c from the second strip-shaped subregion 106be.

In practice, in many embodiments, the described main region 106c, the described edge region 106b and the described subregions 106bd and 106be are not as sharply delimited from one another as shown in the drawing. A possible course of the respective area boundaries is shown by dashed lines.

The current collector 106 of an anode 105 shown in FIG. 1C comprises an edge region 106b, which is coated on both sides with a layer of a support material 133, and a main region 106c, which is coated on both sides with a layer of an electrode material 107. The edge region 106b is completely coated on both sides with the layer of the support material 133.

In practice, in many embodiments, the described main area 106c and the described edge area 106b are not as sharply delimited from each other as shown in the drawing. Instead, there may be overlaps. A possible course of the respective area boundaries is shown by dashed lines.

The current collector 106 of an anode 105 shown in FIG. 1D comprises an edge portion 106b coated on both sides with a layer of a support material 133, and a main portion 106c coated on both sides with a layer of an electrode material 107. The edge region 106b is partially coated with the layer of support material 133. It is subdivided into a first strip-shaped subregion 106bf, which is coated on both sides with the support material 133, and a second strip-shaped subregion 106bg, which is free of the support material 133. The second strip-shaped subregion 106bg is a terminal strip-shaped subregion and the first strip-shaped subregion 106bf is immediately adjacent to the main region 106c of the current collector and separates the main region 106c from the second strip-shaped subregion 106bg. Furthermore, the main region 106c is also completely coated with the electrically non-conductive layer of the support material 133.

In practice, in many embodiments, the described main region 106c, the described edge region 106b and the described subregions 106bf and 106bg are not as sharply delimited from one another as shown in the drawing. A possible course of the respective area boundaries is shown by dashed lines.

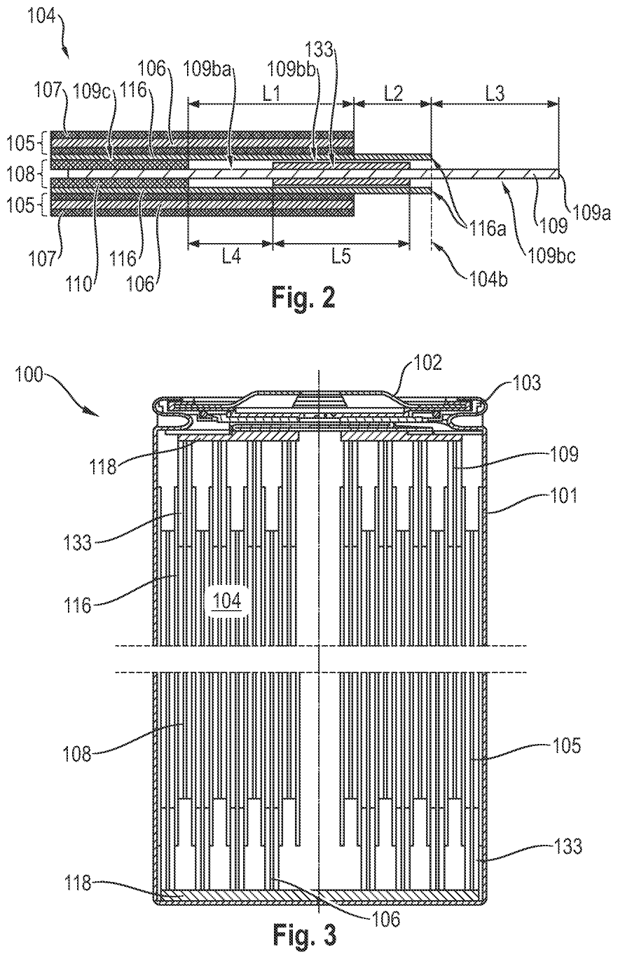

FIG. 2 shows the edges of electrodes of an electrode-separator assembly. A cathode 108 is arranged between two anodes 105, which is connected to the anodes via the separators 116 or the separator 116. The anodes 105 each comprise an anode current collector 106, which is coated on both sides with an electrode material 107. The anode current collectors 106 are copper foils. The cathode 108 comprises a cathode current collector 109, which is a thin aluminum foil. The edges 116a of the separators or separator lie in a plane from which the edge 109a of the current collector 109 protrudes. This plane is defined in the present case as end face 104b. The end face projection of the current collector 109 has the length L3 in the present case.

The cathode current collector 109 comprises a main region 109c, which is loaded on both sides with a layer of positive electrode material 110, and an edge region 109b, which extends in a strip-shaped manner along the edge 109a and which is not loaded with the electrode material 110. The edge region 109b is subdivided into the three strip-shaped, directly adjacent subregions 109ba, 109bb and 109bc, wherein the subregion 109ba is free of the support material 133, the subregion 109bb is coated on both sides with the support material 133, and the subregion 109bc is also free of the support material 133.

It should be emphasized that the separators 116 or the separator 116 have/has a projection of length L2 relative to the negative electrodes 105 in order to prevent direct contact with the cathode 106 in the edge regions of the electrodes 105.

It should also be emphasized that the negative electrodes have a protrusion L1 with respect to the main region 109c. As a result, they completely overlap in the direction perpendicular to the current collector 109 with the subregion 109ba, which in the present case has the preferred length L4.

It should also be emphasized that the subregion 109bb, which has the preferred length L5 in the present case, completely overlaps with the separators 116 or the separator 116 in the direction perpendicular to the current collector 109. Only a part of the subregion 109bb overlaps with the electrodes 105 in the direction perpendicular to the current collector 109.

Exemplary preferred values for the lengths L1 to L5 are as follows:
L1=0.5 mm to 1.5 mm
L2=0.25 mm to 1.25 mm
L3=0.75 mm to 1.75 mm
L4=0.1 mm to 0.9 mm
L5=0.5 mm to 1.5 mm

FIG. 3 shows an example of an energy storage element 100 with an electrode-separator assembly 104. The energy storage element 100 comprises a housing which is closed in an airtight and liquid-tight manner and in which the electrode-separator assembly 104 is arranged. The housing comprises a cup-shaped metallic housing part 101 and a housing lid 102, between which the electrically insulating seal 103 is arranged. The electrode-separator assembly 104 is a winding and comprises the anode 105 and the cathode 108 and the separator 116 each in ribbon-shaped form and wound in a spiral. The electrode-separator assembly 104 is electrically connected to the housing via the metallic contact sheet metal members 117 and 118. The anode 105 is connected to the bottom of the cup-shaped housing part 101 via the contact sheet metal member 117, which accordingly functions as the negative pole of the energy storage element 100. The cathode 108 is connected to the lid 102 via the contact sheet metal member 118, which accordingly functions as the positive pole of the energy storage element 100.

The contact sheet metal members 117 and 118 are welded to the longitudinal edges of the current collectors 106 and 109. The current collectors 106 and 109 are formed as ribbons and each comprise a strip-shaped edge region 106b and 109b coated with the support material 133.

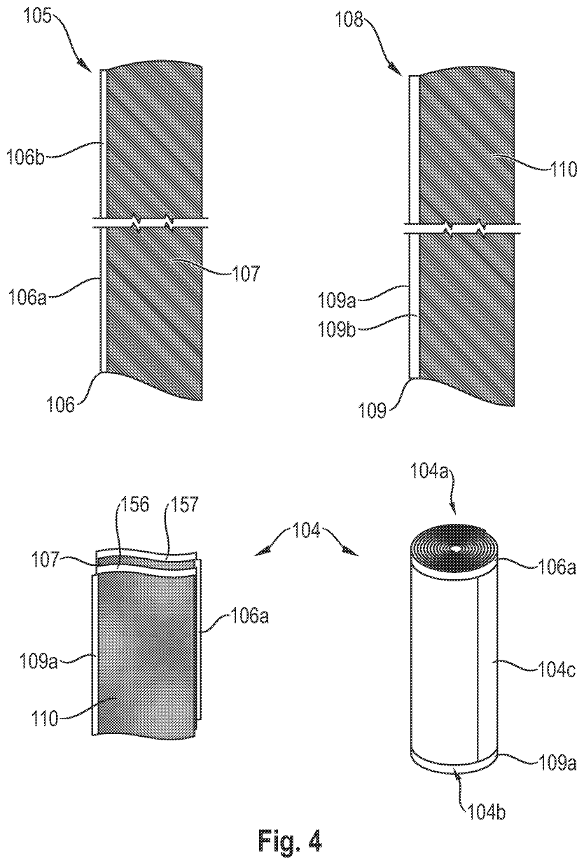

FIG. 4 illustrates the structure of an electrode-separator assembly 104, which can be a component of an energy storage element. The assembly 104 comprises the ribbon-shaped anode 105 with the ribbon-shaped anode current collector 106, which has a first longitudinal edge 106a and a second longitudinal edge parallel thereto. The anode current collector 106 is preferably a foil made of copper or nickel. This comprises a strip-shaped main region, which is loaded with a layer of negative electrode material 107, and a free edge strip 106b, which extends along its first longitudinal edge 106a and which is not loaded with the electrode material 107 but instead with the support material 133. Further, the assembly 104 comprises the ribbon-shaped cathode 108 with the ribbon-shaped cathode current collector 109 having a first longitudinal edge 109a and a second longitudinal edge parallel thereto. The cathode current collector 109 is preferably an aluminum foil. It comprises a strip-shaped main region, which is loaded with a layer of positive electrode material 110, and a free edge strip 109b, which extends along its first longitudinal edge 109a and which is not loaded with the electrode material 110 but with the support material 133. Both electrodes are shown individually in an unwound state.

The anode 105 and the cathode 108 are arranged offset from each other within the electrode-separator assembly 104, so that the first longitudinal edge 106a of the anode current collector 106 protrudes from the first terminal end face 104a and the first longitudinal edge 109a of the cathode current collector 109 protrudes from the second terminal end face 104b of the electrode-separator assembly 104. The offset arrangement can be seen in the illustration at the bottom left. The two ribbon-shaped separators 156 and 157 are also shown there, which separate the electrodes 105 and 108 from each other in the winding.

In the illustration at the bottom right, the electrode-separator assembly 104 is shown in wound form, as it can be used in an energy storage element according to FIG. 1. The electrode edges 106a and 109a protruding from the end faces 104a and 104b are clearly visible. The winding shell 104c is preferably formed by a plastic film.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An electrochemical energy storage element, comprising:
an electrode-separator assembly, comprising:
an anode, a cathode, and at least one separator or solid electrolyte with a sequence anode/separator or solid electrolyte/cathode,
wherein the anode comprises an anode current collector in the form of an electrically conductive substrate having a top side, a bottom side, and an edge,
wherein the cathode comprises a cathode current collector in the form of an electrically conductive substrate having a top side, a bottom side, and an edge,
wherein:
the anode current collector comprises a main region loaded on both sides with a layer of negative electrode material and an edge region not loaded with the negative electrode material that extends in a strip-shaped manner along the edge of the anode current collector, and/or
the cathode current collector comprises a main region loaded on both sides with a layer of positive electrode material, and an edge region not loaded with the positive electrode material that extends in a strip-shaped manner along the edge of the cathode current collector,
wherein the electrode-separator assembly has a side from which a respective edge protrudes, wherein the respective edge is the edge of the anode current collector or the edge of the cathode current collector,
wherein a respective edge region extending along the respective edge is partially or completely coated with an electrically non-conductive layer of a support material, the respective edge region being the edge region of the anode current collector or the edge region of the cathode current collector,
wherein a respective current collector comprising the respective edge protruding from the side has a first mean thickness D1 in a main region thereof and a maximum thickness D2 in an edge region thereof, the respective current collector being the anode current collector or the cathode current collector, and
wherein D2≤D1.

2. The electrochemical energy storage element according to claim 1, wherein at least one of:
the respective edge region is only partially coated with the layer of support material,
the respective edge region is subdivided into a first strip-shaped subregion free of the support material, a second strip-shaped subregion coated on both sides with the support material, and a third strip-shaped subregion free of the support material, and/or
the third strip-shaped subregion is a terminal strip-shaped subregion and the first strip-shaped subregion is immediately adjacent to the main region of the respective current collector and the second subregion separates the first strip-shaped subregion from the third strip-shaped subregion.

3. The electrochemical energy storage element according to claim 1, wherein at least one of:
the respective edge region is only partially coated with the layer of support material,
the respective edge region is subdivided into a first strip-shaped subregion coated on both sides with the support material and a second strip-shaped subregion free of the support material, and/or
the second strip-shaped subregion is a terminal strip-shaped subregion and the first strip-shaped subregion is immediately adjacent to the main region of the respective current collector and separates the main region from the second strip-shaped subregion.

4. The electrochemical energy storage element according to claim 1, wherein at least one of:
the respective edge region is completely coated with the layer of the support material, and/or
the respective edge region is coated on both sides with the layer of the support material.

5. The electrochemical energy storage element according to claim 1, wherein at least one of:
the respective edge region is only partially coated with the layer of support material,
the respective edge region is subdivided into a first strip-shaped subregion coated on both sides with the support material and a second strip-shaped subregion free of the support material,
the second strip-shaped subregion is a terminal strip-shaped subregion and the first strip-shaped subregion is immediately adjacent to the main region of the respective current collector and separates the main region from the second strip-shaped subregion, and/or
the main area of the respective current collector is partially or completely coated with the electrically non-conductive layer of the support material.

6. The electrochemical energy storage element according to claim 1, wherein at least one of:
the electrode-separator assembly is a winding and comprises the anode, the cathode, and the separator or the layer of the solid electrolyte, each in ribbon-shaped form and wound in a spiral,
the winding-shaped electrode-separator assembly has a first end face, a second end face, and a winding shell located therebetween,
the anode current collector is ribbon-shaped and comprises its main region and edge region parallel to one another, the main region being strip-shaped like the edge region,
the cathode current collector is ribbon-shaped comprises its main region and the edge region parallel to one another, the main region being strip-shaped like the edge region,
the edge of the anode current collector protrudes from one of the end faces, the edge of the cathode current collector protrudes from the other of the end faces,
a contact sheet metal member is fixed to the first and/or the second end face, and/or
the contact sheet metal member or the contact sheet metal members are welded to the edge protruding from the respective end face or to the edges protruding from the respective end face.

7. The electrochemical energy storage element according to claim 1, wherein at least one of:
the electrode-separator assembly comprises a plurality of anodes and a plurality of cathodes in stacked form, wherein adjacent electrodes of opposite polarity in the stack are separated by a plurality of separators or a plurality of layers of solid electrolyte,
the anodes comprise anode current collectors that each comprise a main region loaded on both sides with a layer of the negative electrode material and an edge region that extends in a strip-shaped manner along an edge and is not loaded with the negative electrode material,
the cathode current collectors that each comprise a main region loaded on both sides with a layer of the positive electrode material, and an edge region that extends in strips along an edge and is not loaded with the positive electrode material,
the stack is prismatic and has a first side from which the edges of the anode current collectors protrude and a second side from which the edges of the cathode current collectors protrude,
a contact sheet metal member is fixed to the first and/or second side, and/or
the contact sheet metal member or the contact sheet metal members are welded to the edges protruding from the respective side.

8. The electrochemical energy storage element according to claim 1, wherein at least one of:
the support material is a ceramic material,
the support material comprises ceramic particles and a binder, and/or
the ceramic material or ceramic particles are boehmite or γ-AlOOH).

9. The electrochemical energy storage element according to claim 1, wherein at least one of:
the energy storage element comprises an airtight and liquid-tight housing in which the electrode-separator assembly is arranged, and/or
the electrode-separator assembly is electrically connected via the contact sheet metal member to a part of the housing or to an electrical pole passing through the housing.

10. A method of manufacturing an electrochemical energy storage element according to claim 1, the method comprising:
applying a layer of a respective electrode material in the main region of the respective current collector having a top side, a bottom side and an edge;
applying a layer of the support material in an edge region of the respective current collector; and
c. calendering the respective current collector.

11. The method of claim 10, wherein at least one of:
a suspension comprising the support material in particulate and/or dissolved form and a suspending agent is used to apply the layer of support material,
the suspending agent comprises at least one substance from the group consisting of water, N-methyl-pyrrolidone and ethanol,
the suspension comprises a binder,
the suspension comprises the particulate support material with a d50 value in a range from 0.2 μm to 0.5 μm,
the suspension is free of particles with a particle size >2 μm,
the suspension comprises additives that influence its processing properties, and/or
the suspension comprises the following components in the following proportions:

| | | |
|---|---|---|
| Suspension agent | 40-90% | by weight, |
| Particulate support material | 10-60% | by weight, |
| binder | 1-5% | by weight, |
| additives | 0-5% | by weight. |
